(19) United States
(12) Patent Application Publication
(10) Pub. No.: US 2014/0069981 A1
(43) Pub. Date: Mar. 13, 2014

(54) COMBUSTION FASTENING TOOL HAVING LOCK FEATURES

(71) Applicants: Christian Ricordi, Bourg-les-Valence (FR); Alain Vettoretti, Bourg-les-Valence (FR); Frederic Nayrac, Bourg-les-Valence (FR); Patrick Herelier, Saint-Jean-de-Muzols (FR); Pascale Grandjean, Guilherand-Granges (FR); Pierre Cordeiro, Valence (FR); Jean-Michel Dreveton, Livron-sur-Drome (FR)

(72) Inventors: Christian Ricordi, Bourg-les-Valence (FR); Alain Vettoretti, Bourg-les-Valence (FR); Frederic Nayrac, Bourg-les-Valence (FR); Patrick Herelier, Saint-Jean-de-Muzols (FR); Pascale Grandjean, Guilherand-Granges (FR); Pierre Cordeiro, Valence (FR); Jean-Michel Dreveton, Livron-sur-Drome (FR)

(73) Assignee: SOCIETE DE PROSPECTION ET D'INVENTIONS TECHNIQUES SPIT, Bourg-les-Valence (FR)

(21) Appl. No.: 14/005,153

(22) PCT Filed: Sep. 22, 2011
(86) PCT No.: PCT/IB2011/002585

§ 371 Date: Nov. 19, 2013

(30) Foreign Application Priority Data
Mar. 16, 2011 (FR) 1152148

(51) Int. Cl. B25C 1/08; B25C 1/00

(52) U.S. Cl. CPC B25C 1/08; B25C 1/008
USPC 227/8; 227/9

(57) ABSTRACT

A gas setting tool, wasting a limited amount of fuel. The tool comprises i) an internal combustion engine, with a device for injecting fuel in the chamber of the engine, comprising a check valve and an injection piston, the injection piston extending beyond the check valve, and iii) a sealing joint mounted on the injection piston of the check valve. The injection piston comprises an internal bore opened on the exterior and the check valve and its injection piston are arranged so that, in an opening position, the fuel in a container is able, outside the check valve, to only flow through the internal bore of the injection piston. Thanks to this invention, fuel waste is reduced to the best.

### BACKGROUND

This invention relates to so-called gas setting tools, i.e. tools comprising an <<internal combustion engine>> operating through igniting in a combustion chamber an air-fuel mixture, the fuel being injected into the chamber by an injection device from a fuel container referred to as a gas cell. Such tools are intended to drive fastening elements into support materials for fastening parts thereto. Gas nailers are widely used nowadays. As used herein, a gas tool refers to a tool with a propulsion energy source consisting in gas or another fuel for an internal combustion engine, for example, petrol, alcohol, either in a liquid and/or a gas form.

As an injection device, a solenoid valve, a piezoelectric injector could be for example used. An injection device comprises a tubular stem for intake, also referred to as a connection stem or intake stem, a gas cell, and an ejection stem, both stems being generally fitted into a sealing coupling. The ejection stem is mounted in the cell in a pusher and under the action of a move of the stem of the device, the ejection stem is pushed back against the action of a spring for releasing one fuel dose.

An injection device generally comprises a check valve having its valve comprising the intake stem.

It is the same for example for the injection device described in EP 2,119,535.

In the device of such a prior art document, wherein the intake stem comprises an end portion extending beyond the check valve, the flow of fuel from the ejection stem of the cartridge up to the intake stem of the check valve of the device occurs, more particularly, through an annular passage arranged outside the check valve around the end portion of the valve-forming stem of the check valve. Such an arrangement requires providing significant sealing means and machining fuel flow holes in both ejection and intake stems.

Furthermore, as soon as a cell is made integral with an injection device, fuel spreads between the two stems and, beyond, up to the check valve of the device. When the cell is disconnected from the device, all this volume of fuel is wasted. Now, this can amount to several doses, up to several tens, while to-day about a thousand dose cells are used. This is not negligible. This is all the more unfortunate as gas cells have been substituted for powder cartridges precisely because gas provides for a very large number of shots and wasting some of them is rather unfortunate. Thus, the cell-injection device connection should be normally ensured.

The problem the invention of the present application originates from is thus reducing to the best the waste of fuel when the cell is released from the injection device.

### BRIEF DESCRIPTION

Thus, this invention relates to a gas setting tool comprising i) an internal combustion engine, with a combustion chamber, intended for receiving an air and fuel mixture from a fuel container, ii) a device for injecting fuel into the chamber, comprising a check valve and an injection piston slidably mounted in the check valve between a closing position and an opening position of the check valve resulting from the action of an ejection stem of the container, the injection piston extending to this end beyond the check valve, and iii) a sealing joint mounted on the injection piston of the check valve and arranged for receiving an ejection stem of the container of fuel, characterized in that the injection piston comprises an internal bore opened to the outside and the check valve and the injection piston thereof are arranged so that, in the opening position, the fuel in a container can, outside the check valve, only flow through the internal bore of the injection piston.

The fuel in a container flowing inside the injection piston, and not outside as for the tool in the above mentioned prior art document, the tool is simple to manufacture and only requires in the injection device, outside the check valve, the single sealing joint wherein the injection piston is fitted.

As the check valve is actuated directly by the ejection stem assembly of the container, the injection piston and the joint mounted on the piston, actually, the joint located between the piston and the stem of the container, if the container is disconnected from the injection device, the only fuel wasted is the volume of the interior of the piston portion outside the check valve and the ejection stem of the container.

The injection piston could comprise an annular shoulder acting as a valve arranged so as to abut on a check valve seat under the action of a spring.

As a check valve, a ball could also be provided, being pushed back against a check valve seat under the action of a spring and against the action of the above-mentioned assembly.

Advantageously, the check valve is shaped as an injection stem wherein the injection piston is mounted, with a knee wherein a check valve seat is arranged and being able to cooperate with clamping jaws arranged in an adapter for fastening a fuel container to the injection device.

The injection piston could be integral with a tubular portion extending beyond the check valve, the bore of the annular portion being in communication with the interior of the check valve by at least one radial bore.

The injection piston could further comprise a tubular portion extending beyond the check valve and, inside the check valve, a valve portion being able, under the action of a spring, to abut on the valve seat for plugging the check valve and being able to be released therefrom under the action of an ejection stem of the container and via the tubular portion of the injection piston.

### DRAWINGS

These and other features, aspects, and advantages of the present invention will become better understood when the following detailed description is read with reference to the accompanying drawings in which like characters represent like parts throughout the drawings, wherein:

FIG. 1 is an axial sectional view of the assembly of a first embodiment of the fuel injection device of the tool of this invention and of a fuel container, fastened to each other via an adapter, with an injection piston in an opening position of the check valve of the device;

FIG. 2 is a view corresponding to FIG. 1, but with the injection piston in the closing position of the check valve;

FIG. 3 is a partially axial sectional view of a second embodiment of the fuel injection device of the tool of this invention; and

FIG. 4 is a schematic of an embodiment of a combustion driven tool having a plurality of lockout features; and

### DETAILED DESCRIPTION

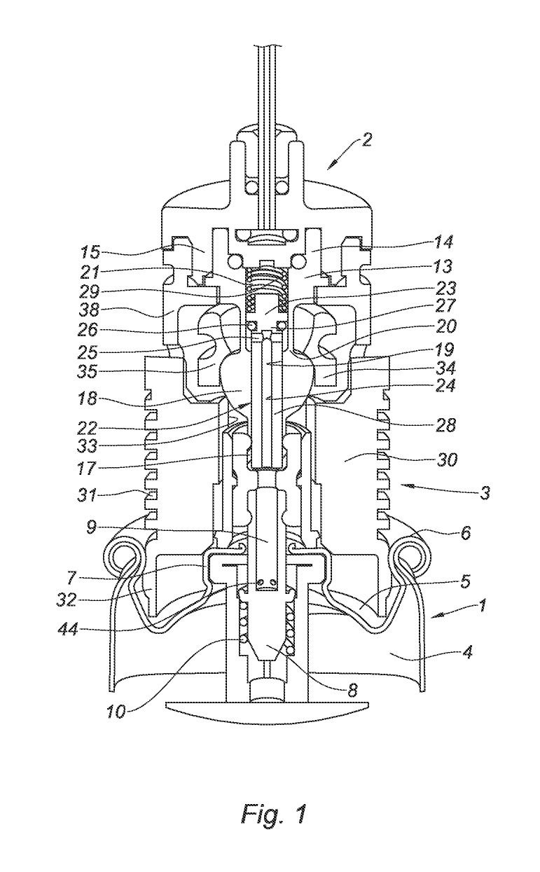

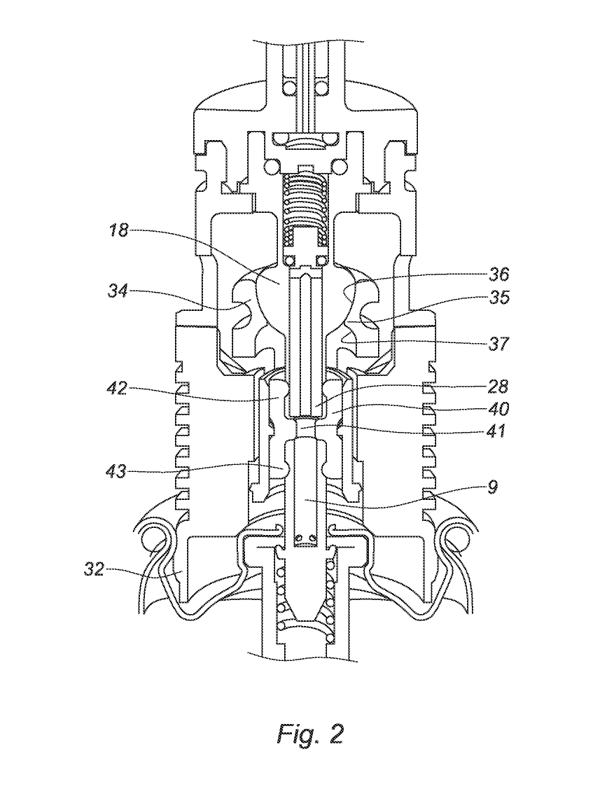

With reference to FIGS. 1 and 2, an assembly will be described now, comprising a fuel cell 1, here, as an injection-dosage device, a solenoid valve 2, an adapter 3 for fastening each other.

The Cell

This a container 4 having an annular cup 5 bound, in periphery, by a bead 6 and, at the centre, by an island 7 for retaining an internal pusher 8 extended by an external ejection stem 9. The ejection stem 9 is a tubular member that can thus be pushed back towards the interior of the cartridge against the action of a return spring 10. All these members of the cartridge 1 are perfectly known to those skilled in the art.

The Solenoid Valve

The solenoid valve 2, only a small part of which is shown on the figures, comprises conventionally a body with a coil, an intake tubular stem 13 and, around the base 14 of the stem 13, a base 15 into which the stem 13, 14 is engaged, the base 15 being in turn engaged into a fastening skirt 38.

More particularly, the intake stem, between its base 14 and its end 17, comprises a belly, or a knee-forming bulge 18 being arranged for providing a latching function of the solenoid valve 2 on the adapter 3, as set forth later on.

The stem 13, in its portion comprising the knee 18 and up to the end 17, comprises an internal bore 19 that, beyond the knee 18, flares so as to form a check valve seat 20 extending by a widened space 21 for receiving a valve head 23. A valve forming piston 22 is indeed slidably mounted in the stem 13 which thus forms a check valve. The piston 22 comprises a head 23 and a tubular leg 28. The tubular leg 28 is drilled with a central bore 24 opening on the exterior of the stem, at its end 17, and on two small radial bores 25, in turn opening on the widened space 21. The tubular leg 28 is connected to the piston head-valve 22 at the level of a groove for receiving an annular seal 26 intended for abutting against the check valve seat 20. The piston head 22 here comprises an annular shoulder 27 acting as an abutment for a return spring 29 for the piston 22 in the closing position of the check valve, the seal 26 in abutment against the check valve seat 20.

For an obvious reason, to be set forth herein after, the length of the piston leg 28 is substantially larger than the length of the stem 13, between the check valve seat 20 and the end 17.

The belly 18 of the intake stem 13 of the solenoid valve here has an external general shape looking like a somewhat ovoid ball, being wider towards the base 14 of the stem 13 than towards the end 17 of the stem. It forms a knee.

The Adapter

This is a tubular body 30 with a grooved external wall 31. It is extended, on the side intended for cooperating with the cartridge 1, by an anchoring skirt 32 in the cup 5, through fitting the skirt 32 in the bead 6 of the cartridge.

From the central bore 33 of the adapter, clamping jaws 34 for the solenoid valve extend through cooperation of such jaws, mounted so as to space apart, with the knee 18 from the intake stem 13 of the solenoid valve. The jaws 34 protrude outside the central bore through their anchoring and clamping end 35 having a concave internal surface 36, substantially corresponding to the external shape of the knee 18. Beyond the end 35, the jaws are recessed so as to show an internal shoulder 37 with a shape complementary to that of the knee 18 in the widest portion thereof

Between the clamping jaws 34 and the anchoring skirt 32, a sealing coupling 40 is mounted. The coupling 40 has here an H-shaped section, with a median wall 41 which is drilled with a passage hole and provides two female sleeves 42, 43 for the two ejection 9 and intake 28 stems of the cartridge and of the solenoid valve.

Operation

The adapter 3 could first be mounted on the cartridge 1 or on the solenoid valve 2. By the way, normally, it is mounted on the cell.

For mounting it on the cell, the skirt 32 is slightly forcibly slid 32 from the adapter into the cup 5, the skirt inserting inside the bead 6, until the interior of the tubular wall of the adapter comes in abutment against the retaining island 7 and the ejection stem 9 against the median wall 41 of the sealing coupling 40.

Afterwards, the solenoid valve 2 is slid into the adapter 3. After the end 17 of the intake stem has moved beyond the ends 35 of the jaws 34, the knee 18 spaces apart such ends so as to slightly forcibly travel until the knee becomes seated under the shoulder 37. Then, the end 17 of the stem 13 is inserted into the sleeve 42 in abutment against the median wall 41 and the fastening skirt 38 is fitted on the tubular body 30 of the adapter.

In this relative position (FIG. 1), the pusher 8 of the cartridge 1 is pushed back against the action of the spring 10, but the stem 9 of the cell has pushed back in the other direction the piston 22 against the action of the spring 29, the piston head 23 being then released from the check valve seat 20. The fuel may flow from the cartridge into the solenoid valve 2 through radial holes 44 in the stem 9, the central bore 24 of the piston 22, the radial bores 25 and the space 21. Outside the flared space 21 of the check valve 13, that is, outside the check valve 13, the fuel only flows through the central bore 24 of the injection piston 22.

It should be noticed that the move of the piston 22 through the stem 9 is possible because of the length of the piston leg 28 being larger than the length of the stem 13, between the seat 20 and the end 17.

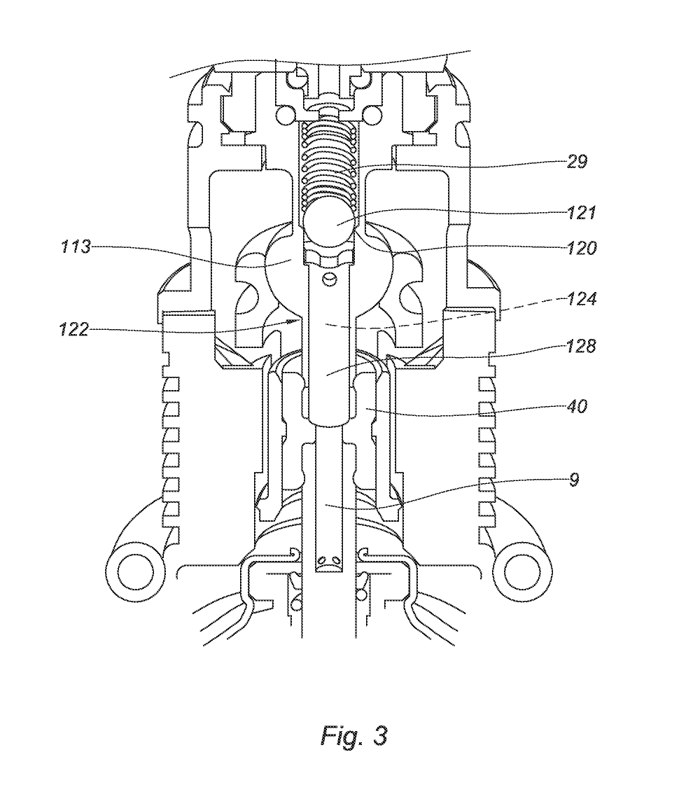

A solenoid valve has been described with a piston and a monobloc piston head formed integrally. There could be further contemplated (FIG. 3) a tubular leg 128 of an injection piston 122, not linked to a piston head, but cooperating with a ball 121, in turn arranged so as to come in abutment against the seat 120 of the check valve 113 under the action of the spring 29.

As in the previous embodiment, all the other components being identical, in the operating position of the assembly, when the pusher 8 of the cell is moved against the action of the spring 10, the stem 9 has moved in the other direction the tubular leg 128 and the ball 121 so as to allow fuel to flow from the cell 1 in the solenoid valve 2 through the central bore 124 of the leg 128.

A intake stem of the solenoid valve has been described, being a piston head or a ball check valve. But these are not limiting features of this invention. Any part or other needle arranged so as to come in abutment against the seat 20 could also be appropriate. Using a membrane, or even a sphincter check valve could also be contemplated.

In the first embodiment, a return spring for the piston 22 has been provided. It should be noticed that this could be omitted, the gas pressure remaining upstream the check valve when the cell acting therefore is removed.

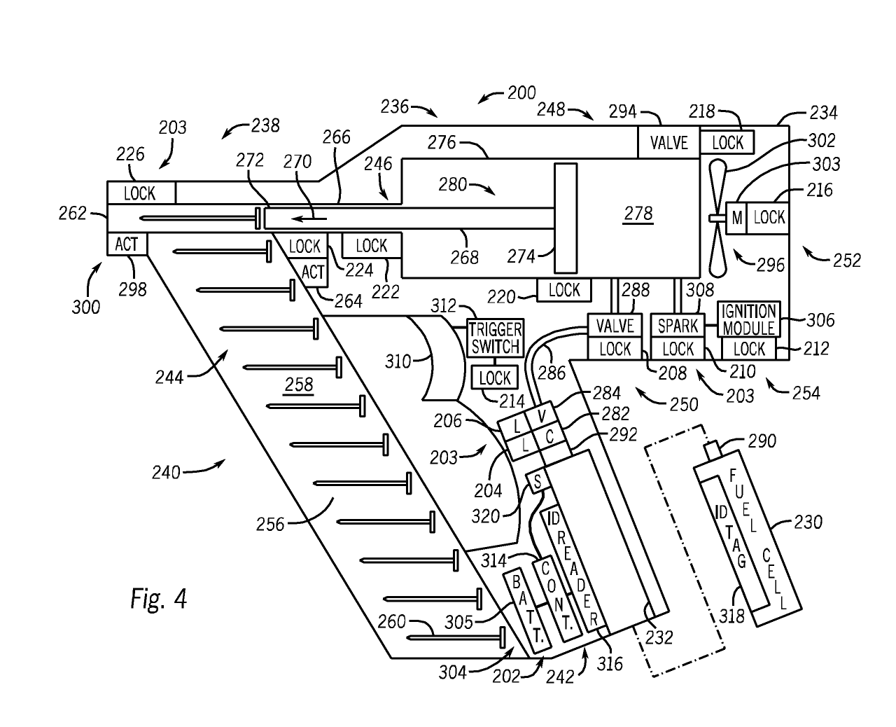

FIG. 4 is a schematic of an embodiment of a combustion driven tool 200 having a plurality of lockout features configured to selectively enable or disable operation of the tool 200. As illustrated, the tool 200 includes a control system 202 coupled to a plurality of locks 204, 206, 208, 210, 212, 214, 216, 218, 220, 222, 224, and 226. The various locks 204-226, referred to collectively as locks 203, may include a variety of mechanically actuated locking mechanisms, electrically actuated locking mechanisms, pneumatically actuated locking mechanisms, software actuated locking mechanisms, wirelessly activated locking mechanisms, optically actuated locking mechanisms, magnetically actuated locking mechanisms, or any combination thereof. For example, the locks 203 may include electrical switches, mechanical switches, or any combination thereof. Accordingly, any reference to the locks 203 (e.g., locks 204-226) in the following discussion are intended to be actuated by any of these mechanisms, among others. The illustrated locks 203 may be actuated by the control system 202 to lockout various components of the tool 200, thereby disabling operation of the tool 200 under certain conditions. For example, the control system 202 may actuate one or more of the locks 203 to reduce waste of fuel, power, fasteners, or other resources of the tool 200. The control system 202 also may actuate one or more of the locks 203 to prevent a combustion event and/or a discharge of a fastener while the tool 200 is not intended to be operated. In certain embodiments, the control system 202 may actuate one or more of the locks 203 to disable various components of the tool 200 when a fuel cell 230 is removed from a fuel cell mount, e.g., receptacle 232, in the tool 200. In particular, when the fuel cell 230 is removed from the tool 200, the control system 202 may actuate one or more of the locks 203 to prevent a flow or leakage of fuel, a flow of air, a generation of a spark to ignite a fuel/air mixture, a combustion event, a feeding of one or more fasteners, a trigger pull, or any movement of various moving parts in the tool 200. This lockout functionality may substantially reduce waste of electrical power and fuel, while also preventing unintended operations while the fuel cell 230 is removed from the tool 200.

In the illustrated embodiment of FIG. 4, the tool 200 includes a housing 234 defined by a body portion 236, a head portion 238, a fastener portion 240, and a handle portion 242. Internally, the tool 200 includes the control system 202, a fastener feeding system 244, a fastener drive system 246, and a combustion system 248. The combustion system 248 also includes a fuel supply system 250, an air supply system 252, and an ignition system 254. These systems 244, 246, and 248 of the tool 200 are configured to feed and drive fasteners into a work piece in response to a combustion event. Accordingly, the control system 202 controls various operational parameters of these systems 244, 246, and 248, as well as various lockout features enabled by the locks 203.

The fastener portion 240 of the tool 200 includes the fastener feeding system 244, which houses a fastener magazine 256 in a fastener feeder 258. The fastener feeder 258 is configured to feed fasteners 260, such as nails or staples, one after another to the head portion 238, such that the fastener drive system 246 can drive the fasteners 260 through a fastener outlet 262. For example, the fastener feeder 258 may include a feeding mechanism or actuator 264, which may sequentially feed the fasteners 260 into a drive rod passage 266. As discussed in detail below, the lock 224 may be coupled to the actuator 264 to selectively lock the feeding of the fasteners 260 to the head portion 238, thereby blocking any fasteners 260 from a position capable of being driven by the fastener drive system 246.

The fastener drive system 246 extends from the body portion 236 to the head portion 238, such that the fastener drive system 246 is driven by a combustion event in the combustion system 248 to drive the fasteners 260 through the fastener outlet 262 in the head portion 238. In the illustrated embodiment, the fastener drive system 246 includes a drive rod 268 disposed in the drive rod passage 266. As indicated by arrow 270, the drive rod 268 is driven in a downstream direction toward the fastener outlet 262, such that a tip 272 of the drive rod 268 impacts the fastener 260 and ejects the fastener 260 through the fastener outlet 262 into a workpiece. As discussed in further detail below, the fastener drive system 246 may include one or more locks 222, which may be actuated by the control system 202 to block movement of the drive rod 268 under certain conditions. In this manner, the locked drive rod 268 is incapable of driving the fasteners 260 from the fastener outlet 262.

The combustion system 248 is disposed in the body portion 236 of the housing 234. As illustrated, the combustion system 248 includes a piston 274 disposed in a cylinder 276, thereby defining a combustion chamber 278. Together, the piston 274 and the drive rod 268 form a piston rod assembly 280. The combustion chamber 278 is configured to combust a mixture of fuel and air to generate pressurized combustion gases, which then drive the piston rod assembly 280 in the downstream direction indicated by arrow 270. In certain embodiments, the combustion system 248 includes one or more locks 220 configured to lock movement of the piston 274 in response to input from the control system 202. For example, the control system 202 may selectively actuate the lock 220 to block movement of the piston 274, while also opening one or more vents to vent any unintended combustion gases and/or disabling other features to prevent a combustion event in the combustion chamber 278.

In the illustrated embodiment, the combustion system 248 includes the fuel system 250 and the air system 252 configured to provide a fuel air mixture in the combustion chamber 278, which mixture is then ignited by the ignition system 254 to generate the combustion gases. The fuel system 250 includes the fuel cell 230 configured to mount to a suitable fuel cell mount (e.g., the receptacle 232), a connector 282, an end of fuel line valve 284, a fuel line 286, and a metering valve 288. The fuel cell 230 is configured to mount within the receptacle 232, such that a fuel output 290 connects with a fuel input 292. In certain embodiments, the fuel output 290 may connect with the fuel input 292 as described in detail above with reference to FIGS. 1-3.

In the illustrated embodiment, the connector 282 is configured to enable or disable the connection between the fuel output 290 and the fuel input 292. For example, the connector 282 may be an electrically driven or mechanically driven connection system, which includes the lock 204, such that the control system 202 can enable or disable the connection between the fuel cell 230 and the tool 200.

For example, the control system 202 may actuate the lock 204 to disable or prevent the connector 282 from coupling the fuel output 290 to the fuel input 292 under certain conditions. In certain embodiments, this lockout feature may prevent an unsuitable fuel cell 230 from causing damage, degraded performance, or malfunction of the tool 200.

Similarly, the end of fuel line valve 284 may be coupled to the lock 206, such that the control system 202 can electrically or mechanically actuate the lock 206 to enable or disable fuel flow through the valve 284. For example, the control system 202 may lock or close the valve 284 to prevent fuel flow and leakage of fuel when the fuel cell 230 is removed from the tool 200. In this manner, the lock 206 may substantially reduce the waste of fuel and environmental impact of the tool 200, while also preventing the possibility of an unintended combustion event within the combustion chamber 278. For example, the actuation of the lock 206 to close the valve 284 may prevent leakage of any fuel through the fuel line 286 from the metering valve 288 to the valve 284 adjacent the receptacle 232. Otherwise, the fuel within the fuel line 286 may inadvertently leak through the fuel line 286 into the receptacle 232. In addition, the metering valve 288 may be controlled by the controlled system 202 to provide a desired rate of fuel flow into the combustion chamber 278 to enable a combustion event. However, the valve 288 may be coupled to the lock 208, which may be controlled by the control system 202 to selectively prevent flow of fuel through the fuel line 286 into the combustion chamber 278. For example, the control system 202 may electrically or mechanically actuate the lock 208 to close the valve 288 when the fuel cell 230 is removed from the receptacle 232.

The air system 252 may include an air valve 294 and a fan 296. For example, the air valve 294 may be controlled by the control system 202 to open during an air purge or air intake into the combustion chamber 278, while the valve 294 may be closed in preparation for the combustion event in the chamber 278. In certain embodiments, the valve 294 may be actuated by an actuator 298 of a workpiece contacting element 300. For example, as the workpiece contacting element 300 engages a workpiece, the actuator 298 may mechanically or electrically actuate the valve 294 and other features (e.g., fan 296 and fuel system 250) of the combustion system 248 in preparation of a combustion event. In such an embodiment, the control system 202 may selectively actuate the lock 226 to disable the actuator 298, and in turn lock the valve 294, depending on various conditions sensed by the control system 202. However, in the illustrated embodiment, the lock 218 is coupled to the valve 294, such that the control system 202 can selectively enable or disable the valve 294 depending on various conditions sensed by the control system 202. For example, the control system 202 may electrically or mechanically actuate the lock 218 to open the valve 294 (e.g., to function as a vent) when the fuel cell 230 is removed from the receptacle 232. Similarly, the fan 296 may be coupled to the lock 216, which may be controlled by the control system 202 to enable or disable operation of the fan 296 depending on various conditions. In the illustrated embodiment, the fan 296 includes a plurality of blades 302 coupled to a motor 303. The motor 303 may be electrically driven by a power supply system 305, e.g., a battery 305, in the tool 200. However, under certain conditions, the lock 216 may be actuated to deactivate the motor 303 in response to a control signal from the control system 202. For example, the control system 202 may engage the lock 216 to switch off the fan 296 in response to an absence or removal of the fuel cell 230 from the receptacle 232. Accordingly, the locks 216 and 218 may be used alone or together to lockout aspects of the air system 252 to prevent an undesired combustion event in the combustion chamber 278 in response to control signals from the control system 202.

The ignition system 254 includes an ignition module 306 and a spark source 308, such as a spark plug. The ignition system 254 is configured to generate a spark to ignite a fuel air mixture within the combustion chamber 278. Accordingly, the ignition system 254 may include the lock 210 coupled to the spark source 308 and the lock 212 coupled to the ignition module 306, such that the control system 202 can selectively enable or disable the generation of a spark to combust the fuel air mixture within the chamber 278. For example, similar to the discussion above, the locks 210 and 212 may be electrically or mechanically actuated by the control system 202 in response to various conditions, such as a sensed removal or absence of the fuel cell 230 in the receptacle 232.

The combustion system 248 may be designed to initiate the combustion event in the chamber 278 in a variety of ways. However, the tool 200 generally includes a trigger 310 coupled to a trigger switch or actuator 312, which is configured to initiate the combustion event. For example, the trigger 310 may be pulled to engage the trigger switch 312, which then causes the ignition system 254 to generate a spark to combust the fuel air mixture in the chamber 278. In other embodiments, the trigger 310 may be pulled to actuate the fuel system 250 and the air system 252 to provide air and fuel into the combustion chamber 278 prior to the spark being generated by the ignition system 254. In the illustrated embodiment, the injection of fuel and air into the combustion chamber 278 may be actuated by the actuator 298 of the workpiece contacting element 300. For example, as the workpiece contacting element 300 engages a workpiece, the actuator 298 may be depressed to trigger the fuel system 250 to inject fuel into the combustion chamber 278 and trigger the air system 252 to close the valve 294 and engage the fan 296. In certain embodiments, the control system 202 may be designed to interact with the actuator 298, the fuel system 250, the air system 252, the ignition system 254, and the trigger switch 312 to control the combustion of fuel and air within the combustion chamber 278. Furthermore, the control system 202 may selectively actuate the locks 226 and 214 to lockout the actuator 298 and/or the trigger switch 312. Accordingly, the control system 202 can selectively lockout the workpiece contacting element 300 and the trigger 310 to disable the fuel system 250, the air system 252, and the ignition system 254, such that a combustion event cannot occur. The control system 202 may perform these lockouts in a variety of situations, such as the removal or absence of the fuel cell 230 from the receptacle 232.

In the illustrated embodiment, the control system 202 includes a controller 314 coupled to the battery 305 and identification reader 316. The controller 314 is also coupled to the plurality of locks 203, the fuel system 250, the air system 252, the ignition system 254, the fastener feeding system 244, and other elements within the tool 200. As discussed above, the controller 314 may respond to an input to selectively actuate one or more of the locks 203 (e.g., locks 204-226) to disable one or more functional components of the tool 200 under certain circumstances. In the illustrated embodiment, the input may be derived from the identification reader 316, which may communicate with an identification tag 318 disposed on the fuel cell 230. For example, the identification tag 318 may include a smart tag, such as a radio frequency identification (RFID) tag, a bar code, or another sort of tag having readable information about the fuel cell 230. In certain embodiments, the RFID tag 318 may be an active RFID tag or a passive RFID tag. Furthermore, the RFID tag 318 may include an antenna and memory storing a variety of information.

For example, the identification tag 318 may include information about a fuel type, fuel characteristics, a quantity of fuel, an air/fuel mixture, an ignition type, a fuel metering flow rate, an air flow rate, an identification number or code, a manufacturer, or any combination thereof. The fuel type may include an indication of gas, liquid, or solid fuel. The fuel characteristics may include a fuel composition, a heating value of the fuel, or other information impacting the performance of the fuel in the tool 200. The quantity of fuel may include a total volume of fuel, a number of expected/remaining rounds of combustion events, or a combination thereof. The air/fuel mixture may include one or more optimal air/fuel mixture ratios based on the fuel type, fuel characteristics, tool type, and other factors. Likewise, the ignition type may include one or more optimal ignition types based on the fuel type, fuel characteristics, tool type, and other factors. The ignition types may include a number of sparks (e.g., 1, 2, 3, or more), an intensity of sparks (e.g., low, medium, or high), a timing of sparks, or any combination thereof, for each combustion event. The fuel metering flow rate may include one or more optimal fuel flow rates based on the fuel type, fuel characteristics, air/fuel mixture, tool type, and other factors. Similarly, the air flow rate may include one or more optimal air flow rates based on the fuel type, fuel characteristics, air/fuel mixture, tool type, and other factors. The identification number may include a serial number, a model number, a security code, or any combination thereof. Furthermore, the identification number, and any other information on the tag 318, may be encrypted to prevent tampering. Accordingly, the information stored on the tag 318 may be specifically used to identify and authenticate the fuel cell 230 for use with the tool 200, while the information also may be used to enhance performance of the tool 200.

For example, each of these items of information on the identification tag 318 may be used by the controller 314 to ensure optimal performance (e.g., combustion) of the combustion system 248, while also reducing waste of fuel, waste of electrical power, and waste of fasteners by the tool 200. For example, the controller 314 may use the information on the tag 318 to optimize the fuel flow rate, air flow rate, air/fuel mixture, ignition type, and so forth. The information also may be used by the controller 314 to reduce the possibility of malfunctions, damage, premature wear, or other detrimental impacts on the tool 200. For example, the controller 314 may use the information on the tag 318 to prevent certain operations having too many unknowns or uncertainties. In particular, if the controller 314 is unable to access the information (e.g., unknown fuel cell 230, missing tag 318, or missing information), then the controller 318 may lock down the tool 200 as a protective measure. Likewise, the information may be used by the controller 314 to reduce undesirable emissions by the tool 200. For example, the controller 314 may use the information on the tag 318 to more efficiently use the fuel within the fuel cell 230, thereby increasing the number of fasteners driven by the tool 200 per fuel cell 230. For example, the controller 314 may process the information to determine a reduced fuel injection quantity per combustion event. The information on the tag 318 also may be used by the controller 314 to more efficiently use power in the battery 305 to drive the fan 296, the ignition system 254, and other components of the tool 200, thereby substantially increasing the hours of use of the tool 200 per charge of the battery 305. For example, the controller 314 may disable the power supply system, e.g., battery 305, when the fuel cell 230 is removed from the receptacle 232 to conserve battery power, while simultaneously blocking an unintended ignition by the ignition system 254.

As appreciated, the identification reader 316 is configured to read and/or write information to the identification tag 318 on the fuel cell 230 while the fuel cell 230 is disposed in the receptacle 232 of the tool 200. In certain embodiments, the communication between the reader 316 and the tag 318 may be used by the controller 314 to identify the presence or absence of the fuel cell 230 relative to the receptacle 332. Accordingly, in some embodiments, the reader 316 and tag 318 may collectively define a sensing element that may be used by the controller 314 to determine when the fuel cell 230 is absent or present, thereby enabling the controller 314 to actuate the locks 203 when the fuel cell 230 is absent and disable the locks 203 when the fuel cell 230 is present in the receptacle 232. In certain embodiments, the controller 314 may be coupled to one or more sensors 320, which may be used to identify the presence or absence of the fuel cell 230 in the receptacle 232. For example, the sensor 320 may be a mechanical switch, an electrical switch, an optical sensor, a magnetic sensor, or any combination thereof.

Regardless of the technique used to identify the presence or absence of the fuel cell 230 in the receptacle 232, the controller 314 may respond to an absence of the fuel cell 230 by actuating one or more of the locks 203 (e.g., 204-226) to lockout operation of one or more components of the tool 200. Likewise, even if a fuel cell 230 is present in the receptacle 232, the controller 314 may actuate one or more of the locks 203 (e.g., 204-226) to lockout operation of one or more components of the tool 200 if the controller 314 is unable to authenticate the fuel cell 230 and/or the fuel cell 230 does not meet certain minimum criteria. For example, the tool 200 may require certain minimum performance standards in the fuel cell 230. If the performance standards are not met, then the tool 200 may be subject to unexpected behaviors, such as tool damage, fuel waste, and so forth. Accordingly, the controller 314 may actuate the locks 203 if the tag 230 is not detected, the tag 230 is detected but the information is missing or invalid, or the tag 230 is detected but the information indicates that the fuel cell 230 does not meet the minimum criteria for the tool 200. In certain embodiment, the tag 230 may store a security code, authentication key, or the like, which is conveyed by the reader 316 to the controller 314 to disable the locks 203. If the controller 314 does not receive this security code, authentication key, or the like (e.g., missing or invalid fuel cell 230, tag 318, or information), then the controller 314 actuates the locks 203 to protect the tool 200, prevent unintended operations, and conserve resources (e.g., fasteners 260, fuel, and electrical power). Again, the controller 314 may close the valve 284 (e.g., at an end portion of the fuel line 286 near the fuel cell 230) to prevent fuel leakage and waste while the fuel cell 230 is removed from the receptacle 232. Finally, the controller 314 may rely on various information stored on the tag 318 to improve the performance, efficiency, environmental friendliness, serviceability, and life of the tool.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a combustion fastening tool, comprising:
a fuel cell mount configured to support a fuel cell;
an identification reader configured to read a tag disposed on the fuel cell while the fuel cell is disposed on the fuel cell mount, wherein the tag comprises information;
at least one lock configured to lock out operation of the combustion fastening tool; and
a controller configured to communicate with the identification reader and the at least one lock, wherein the controller is configured to activate the at least one lock if the identification reader is unable to read the tag or the information, or the controller is configured to deactivate the at least one lock if the identification reader is able to read the tag or the information.

2. The system of claim 1, wherein the controller is configured to activate the at least one lock if the identification reader is unable to read the tag or the information

3. The system of claim 1, wherein the controller is configured to deactivate the at least one lock if the identification reader is able to read the tag or the information.

4. The system of claim 1, wherein the combustion fastening tool comprises a fuel valve disposed at an end portion of a fuel line proximate a connection with the fuel cell, and the fuel valve is configured to contain fuel within the fuel line while the fuel cell is not present.

5. The system of claim 4, wherein the fuel valve comprises a check valve.

6. The system of claim 4, wherein the fuel valve comprises an electronic actuator configured to close the fuel valve in response to removal of the fuel cell from the fuel cell mount.

7. The system of claim 4, wherein the fuel valve comprises a mechanical actuator configured to close the fuel valve in response to removal of the fuel cell from the fuel cell mount.

8. The system of claim 4, wherein the at least one lock comprises the fuel valve.

9. The system of claim 1, wherein the identification reader is configured to sense removal of the fuel cell from the fuel cell mount by sensing a removal of the tag.

10. The system of claim 1, wherein the controller is configured to process the information to reduce waste of fuel or electrical energy by the combustion fastening tool.

11. The system of claim 1, wherein the controller is configured to process the information to prevent a malfunction or an unintended operation of the combustion fastening tool.

12. The system of claim 1, wherein the identification reader comprises a radio frequency identification (RFID) reader, and the tag comprises an RFID tag.

13. The system of claim 1, wherein the at least one lock comprises an electrically actuated lock, a mechanically actuated lock, a pneumatically actuated lock, or a combination thereof.

14. The system of claim 1, wherein the at least one lock is configured to lock at least part of a fuel supply system.

15. The system of claim 14, wherein the fuel system comprises a fuel valve disposed at an end portion of a fuel line, and the at least one lock is configured to lock the fuel valve in a closed position to block leakage of fuel from the fuel line while the fuel cell is not present.

16. The system of claim 1, wherein the at least one lock is configured to lock at least part of an air supply system.

17. The system of claim 16, wherein the air supply system comprises a first lock coupled to an air valve, or a second lock coupled to a fan, or a combination thereof.

18. The system of claim 1, wherein the at least one lock is configured to lock a piston, a drive rod, or a combination thereof.

19. The system of claim 1, wherein the at least one lock is configured to lock a trigger.

20. The system of claim 1, wherein the at least one lock is configured to lock a fastener feeder system.

21. The system of claim 1, wherein the at least one lock is configured to lock a power supply system.

22. The system of claim 1, wherein the at least one lock is configured to lock at least part of an ignition system.

23. A system, comprising:
a combustion fastening tool, comprising:
a fuel cell mount configured to support a fuel cell;
an identification reader configured to read a tag disposed on the fuel cell while the fuel cell is disposed on the fuel cell mount, wherein the tag comprises information;
at least one lock configured to lock out operation of the combustion fastening tool, wherein the at least one lock is coupled to a fuel supply system, an air supply system, a power supply system, a fastener drive system, a fastener feeding system, a piston, a trigger, a work piece contact actuator, or a combination thereof; and
a controller configured to communicate with the identification reader and the at least one lock, wherein the controller is configured to activate the at least one lock if the identification reader is unable to read the tag or the information, or the controller is configured to deactivate the at least one lock if the identification reader is able to read the tag or the information.

24. The system of claim 23, wherein the controller is configured to activate the at least one lock if the identification reader is unable to read the tag or the information

25. The system of claim 23, wherein the controller is configured to deactivate the at least one lock if the identification reader is able to read the tag or the information.

26. The system of claim 23, wherein the at least one lock is coupled to the fuel supply system.

27. The system of claim 23, wherein the at least one lock is coupled to the air supply system.

28. The system of claim 23, wherein the at least one lock is coupled to the power supply system.

29. A system, comprising:
a combustion fastening tool controller configured to communicate with an identification reader to read a tag disposed on a fuel cell while the fuel cell is mounted to a combustion fastening tool, wherein the combustion fastening tool controller is configured to activate at least one lock to lock out operation of the combustion fastening tool if the identification reader is unable to read the tag or information stored on the tag or the combustion fastening tool controller is configured to deactivate the at least one lock to enable operation of the combustion fastening tool if the identification reader is able to read the tag or the information stored on the tag,
wherein the at least one lock is configured to lock a fuel supply system, an air supply system, a power supply system, a fastener drive system, a fastener feeding system, a piston, a trigger, a work piece contact actuator, or a combination thereof.

30. A system, comprising:
a combustion fastening tool, comprising:
a combustion chamber;
a fastener drive configured to drive a fastener in response to combustion of a mixture of fuel and air in the combustion chamber;
a fuel supply system configured to supply the fuel to the combustion chamber, wherein the fuel supply system comprises a fuel cell mount configured to support a fuel cell in a fuel cell region, a fuel line extending between the fuel cell region and the combustion chamber, and a fuel valve coupled to an end portion of the fuel line proximate the fuel cell region; and
wherein the fuel valve is configured to block leakage of the fuel from the fuel line while the fuel cell is removed from the fuel cell mount.

31. The system of claim 30, wherein the fuel valve comprises a check valve.

32. The system of claim 30, wherein the combustion fastening tool comprises a mechanical actuator configured to close the fuel valve in response to removal of the fuel cell from the fuel cell mount.

33. The system of claim 30, wherein the combustion fastening tool comprises an electronic actuator configured to close the fuel valve in response to removal of the fuel cell from the fuel cell mount.

34. The system of claim 30, wherein the combustion fastening tool comprises an identification reader configured to read a tag disposed on the fuel cell while the fuel cell is disposed on the fuel cell mount, and the combustion fastening tool is configured to close the fuel valve if the identification reader does not sense the tag or information stored on the tag.

35. A gas setting tool comprising i) an internal combustion engine, with a combustion chamber, intended for receiving an air and fuel mixture from a fuel container, ii) a device for injecting fuel in the chamber, comprising a check valve and an injection piston slidably mounted in the check valve between a closing and an opening position of the check valve occurring under the action of an ejection stem of the container, the injection piston extending, to this end, beyond the check valve, and iii) a sealing joint mounted on the injection piston of the check valve and arranged so as to receive an ejection stem of the fuel container, characterized in that the injection piston comprises an internal bore opened on the exterior and the check valve and its injection piston are arranged so that, in the opening position, the fuel in a container can, outside the check valve, only flow through the internal bore of the injection piston.

36. The setting tool according to claim 35, wherein the check valve is shaped as an injection stem in which the injection piston is mounted, with a knee in which a check valve seat is arranged and being provided so as to cooperate with clamping jaws arranged in an adapter for attaching a fuel container to the injection device.

37. The setting tool according to claim 35, wherein the injection piston is integral with a tubular portion extending beyond the check valve, the bore of the tubular portion communicating with the interior of the check valve through at least one radial bore.

38. The setting tool according to claim 35, wherein the injection piston comprises a tubular portion extending beyond the check valve and, inside the check valve, a valve portion being able to, under the action of a spring, come in abutment against the valve seat so as to plug the check valve and able to be released therefrom under the action of an ejection stem of the container and through the tubular portion of the injection piston.

39. The setting tool according to claim 35, wherein the injection piston comprises an annular shoulder acting as a valve arranged so as to come in abutment against a seat of the check valve, under the action of a spring.

40. The setting tool according to claim 35, wherein the valve of the check valve is a ball pushed back against a check valve seat by a spring.
